(19) United States
(12) Patent Application Publication
(10) Pub. No.: US 2009/0029311 A1
(43) Pub. Date: Jan. 29, 2009

(54) METHOD AND APPARATUS FOR WHITENING TEETH

(75) Inventor: Wyman Chan, London (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: SMILE STUDIO (UK) LIMITED, London (GB)

(21) Appl. No.: 12/161,840

(22) PCT Filed: Jan. 24, 2006
(86) PCT No.: PCT/GB2006/000239

§ 371 Date: Jul. 23, 2008

(51) Int. Cl. A61C 17/00

(52) U.S. Cl. 433/29; 433/216

(57) ABSTRACT

An apparatus (1) for use in whitening teeth comprises support means (7) for being worn on a person's body, a source of radiant heat (9) and position adjusting means (5) connected to said source (9) and said support means (7) for enabling the source (9) to be adjusted to and held in a position adjacent to the person's teeth.

This invention relates to a method and apparatus for whitening teeth, for example cosmetic whitening of teeth.

Dental treatment to whiten teeth has become increasingly popular in recent years. Consequently, several methods and tools have been developed to improve both the effectiveness and the convenience of traditional techniques.

One such technique comprises fitting a dental tray containing whitening solution or gel, which comprises an active oxidising ingredient such as hydrogen or carbamide peroxide, to one arch of a patient's teeth (i.e. the top teeth or the bottom teeth) thereby maintaining the whitening gel in contact with the teeth. The tray is then kept in place for a requisite period of time, generally at intervals each day or every two or three days.

The requisite time may be reduced by increasing the decomposition rate of the active ingredient. One known method of achieving this is by including chemical activators in the gel and using a lamp to apply ultra-violet radiation to the gel, whereby the activators react to the ultra-violet radiation and are said to accelerate the decomposition rate. This is sometimes referred to as “power bleaching”. A number of different lamp designs capable of providing the required ultra-violet light are known. These lamps generally emit radiation with a wavelength in the range from 340 nm to 600 nm (UVA to visible).

A power bleaching treatment typically takes an hour to deliver up to 8 shade improvement on the “Vita shade guide”. Therefore, it is not a quick procedure and consequently takes up valuable surgery time. Hence any proven method that reduces procedure time by improving the effectiveness of the gel and/or decreasing exposure time would be welcomed by dentists and patients alike.

Some of the lamps used in power bleaching are no more than curing lights with optical adapters added to spread the concentrated output from curing lights over a larger area. The optical adapters or mouthpieces take the shape of a full arch over the teeth where those within the smile zone (L4 to R4) are illuminated simultaneously.

Another design involves using a high energy UV bulb enclosed in a shell with an arched mouthpiece at one end through which light emerges. In order to yield light of wavelength within a specific band, a complex set of optical filters is used. The power rating of this lamp is substantial at over 200 W. The heat generated has to be carried away from the patient using a powerful fan, which introduces noise and increases the size and weight of the, already bulky, shell.

Yet another design employs four powerful light bulbs contained inside a ventilated box and uses fibre optics to deliver the usable energy to the patient's teeth via a mouthpiece.

The lamps are generally mounted on a stand or trolley with lever mechanisms to position the heads in front of the individual's mouth. Such stands are inherently large and require excessive space. They are sometimes cumbersome and difficult to manoeuvre.

In order for the lamp to work effectively, a fixed distance must be maintained between the lamp and the individual's teeth. With the lamp fixed in relation to the lamp stand, it requires the individual to remain virtually motionless during the treatment, hindering the comfort of the individual.

Ultra-violet lamps also tend to be bulky and difficult to adjust, requiring the individual to keep still with his or her teeth at a set distance from it. As each whitening session may be quite long, the individual may be discomfited.

FR 2645734 discloses a breast plate mounted light for irradiation of a person's teeth by UV light. The light is powered by a bulky power supply which necessitates that the patient is immobile during treatment.

There is currently some debate within the dental community as to whether or not whitening lamps actually work. Some ‘split arch’ studies have concluded that there is no enhancement of bleaching using a UV lamp.

Heating of the gel, and consequently the active ingredient, may occur as a side effect of the ultra-violet radiation from the lamp, which will also speed up the reaction. While this may improve the effectiveness of the whitening process, it is likely to be difficult to control, and it may result in damage to the teeth and/or discomfort to the individual. Indeed, Zach & Cohen (Oral. Surg. Oral. Med. Oral. Pathol: 19; pp 515-530 (1965)) have reported that a temperature rise of 5.6° C. of the pulp caused 15% pulp to lose vitality, and a 11.2° C. rise caused 60% of the pulp to lose vitality. Consequently, it is usual for optical filters to be used in UV lamps to prevent or at least partially or substantially inhibit IR emissions.

An object of this invention is to provide an improved apparatus and method for teeth whitening which allows the individual whose teeth are being whitened to move during the treatment, thereby improving the individual's comfort and which may not require bulky UV lamp apparatus.

According to one aspect of the invention there is provided an apparatus for use in whitening teeth, the apparatus comprising support means for being worn on a person's body, a preferably regulatable, source of radiant heat, and position adjusting means connected to said source and said support means for enabling the source to be adjusted to and held in a position adjacent to the wearer's teeth.

There is further provided, in a second aspect of the invention, head mountable teeth irradiating apparatus, the apparatus comprising mounting means to be worn on a person's head and a source of electromagnetic radiation connected to said mounting means, said radiation source being operable to direct, in use, radiation on to or towards a wearer's mouth.

The radiation source may comprise a IR and/or a UV source.

Advantageously, the apparatus comprises temperature sensing means for sensing the temperature of gel on the surface of said wearer's teeth, and regulating means responsive to the temperature sensing means and said source for regulating the temperature of said gel.

The source may comprise an array of light emitting diodes (LEDs), for example IR LEDs.

Advantageously, the support means comprises a frame for being worn over the bridge of the nose and above the ears in the manner of the frame of a pair of spectacles.

Preferably, the radiation or radiant heat source comprises a plurality of sources. The or each source may be shaped to at least partially correspond in shape to the part of the wearer's teeth it or they are adjacent.

Advantageously, the frame supports electronic visual entertainment means, for example a visual display screen viewable by said person.

According to another aspect of the invention there is provided a method for whitening, for example cosmetic whitening of, a person's teeth in which a solution or gel containing an oxidising agent is applied to the teeth and said gel is warmed and maintained at a regulated temperature by an infrared radiation source, the source being supported by support means worn on said person's body, for example by a frame for being worn over the bridge of the nose and above the ears in the manner of the frame of a pair of spectacles.

Therefore, the invention provides a bleaching lamp which delivers infrared radiation to warm up teeth to be bleached within accurate limits and can thereby significantly increase the speed of teeth whitening.

For a better understanding of the invention and to show how the same may be carried into effect, reference will now be made, by way of example, to the accompanying drawings, in which:

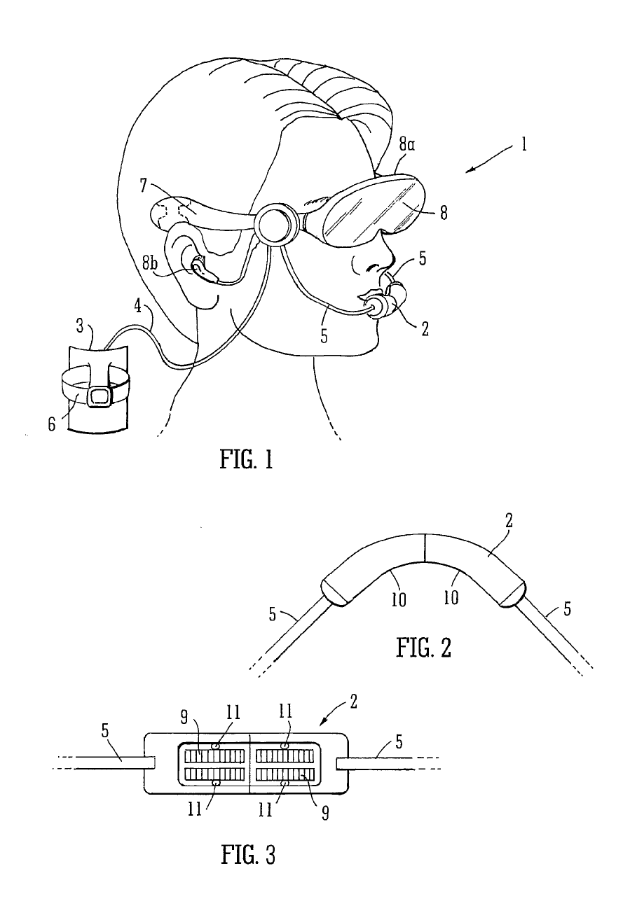

FIG. 1 is a perspective view of a teeth whitening lamp;

FIG. 2 is a top view of part of the FIG. 1 lamp; and

FIG. 3 is a front view corresponding to FIG. 2.

A lamp 1 is shown in the Figures which comprises a portable, wearable, infrared heat source 2. It is closed-loop temperature controlled using non contact temperature measurement device. It comprises an over temperature trip, a no temperature trip and a split arch design to better follow the contour of the teeth. It provides accurate positioning using a retractor as a locator. It provides close zone heating, low power, which has no effect on operating temperature and is battery powered. As well as providing added value in the whitening process, it enhances wearer comfort and entertainment. Moreover, it is safe and effective.

The bleaching lamp 1 consists of a light-weight lamp head 2, a power unit 3 and a cable 4 connecting the two. The power unit 3 contains a power pack and a central control unit (not separately shown). The power pack can be recharged and has sufficient power to operate the lamp for over 3 hours. The power unit can be strapped to an arm band 6 and worn by the person.

The lamp head 2 is less than 300 g in weight and has two arms 5 that swing in from either side of the person's head to form an arch over the person's mouth. The two arms 5 are mounted on the frame 7 of eyewear 8a that provides support. Additionally, eyewear 8a can deliver visual entertainment to the person at the same time, e.g. a person can watch a video DVD video on a monitor 8 and lens (not separately shown) forming a virtual 29″ screen. The two arms 5 are pivotally mounted to the frame 7 by hinges to provide easy adjustment. The arm 5 may be adjustable to allow the lamp head 2 to be located at the appropriate position for whitening.

A cheek retractor (not shown) sitting in the person's mouth is used as a locator to accurately align the lamp head 2 relative to the person's teeth. The person can move his/her head freely without affecting the operation of the lamp 1.

Owing to this method of mounting the lamp head 2 relative to the person's head instead of to a stand fixed to the floor, the light source can be mounted very close (e.g. 25 mm) to the teeth and deliver accurate zonal heating. The required temperature rise is usually less than 10° C., hence the thermal power required is low. An array of infrared LED's 9 are used as heat a source because of their small size, reliability and controllability. An array of LED's are formed into two arches 10 that follow or at least approximate the contour of the smile zone teeth, supplying heat evenly over the teeth. Power to the LED's can be controlled precisely by adjusting the DC current through them or by pulse modulation. Power to individual LED's can be controlled to give more precise heating effect if necessary and thereby allowing heating of individual teeth or groups of teeth.

Four non-contact sensors 11 are mounted on the lamp head 2 to monitor the temperature of gel on the teeth surfaces. Non-contact sensors 11 do not interfere with the bleaching process and are much easier to use in a clinical environment. For control purposes, the LED array 9 is divided into four quadrants corresponding to four quadrants of the smile zone (i.e. left, right, upper, lower) with one sensor 11 in each quadrant. Signals from these sensors 11 are fed back to a central control unit that regulates power delivered to each zone. There could be more or less than four independently controllable quadrants and sensors 11.

In bleaching reactions it is known that the higher the temperature of a bleaching gel, the greater the rate of the chemical reaction, for example the decomposition rate might double at 45° C. However, and as discussed above, there is a risk of pupil damage when a tooth is exposed to an excessive temperature. Too great a temperature may also be uncomfortable for the person.

Herein, it is ensured that the lamp is controlled so that the temperature rise of the gel (due to the lamp) preferably does not rise above 10° C.

The control may be arranged so the temperature rise is more than 10° C., for example 12° C., 15° C. or 20° C., or it could be less for example 9° C., 8° C., 7° C., 6° C., 5° C., 4° C., 3° C., 2° C. or 10° C.

In the lamp 1 described herein, an accurate temperature controlled heat source is used to maintain surface temperature of the teeth to deliver the benefit without introducing the associated problems.

The risk of pupil injury is addressed by an independent circuitry (not shown) that shuts down the power to the LED's and sounds a bleeper should the temperature of the teeth rise above a certain limit. The temperature sensed by the sensors 11 may be displayed for the dentist to monitor. The emission time of the sources 9 may be pre-set according to a pre-determined regime.

The low power design of the lamp 1 allows it to be operable by battery. As will be understood, the lamp 1 is portable, allowing the person freedom of movement. The DVD eyewear and accompanying earplugs 8b provides an added advantage that can make the wearer feel more comfortable by providing a distraction.

Other IR sources may be used.

The apparatus can be used for irradiating teeth in cosmetic whitening (or non cosmetic whitening) operations wherein plaque and other readily removeable matter has previously been removed from the person's teeth.

1-14. (canceled)

15. An apparatus for use in whitening teeth, the apparatus comprising support means for being worn on a person's body, a source of radiant heat and position adjusting means connected to said source of radiant heat and said support means for enabling said source of radiant heat to be adjusted to and held in a position adjacent to the person's teeth.

16. Head mountable teeth irradiating apparatus, said apparatus comprising support means to be worn on a person's head and a source of electromagnetic radiation connected to said support means, said source of electromagnetic radiation being operable to direct radiation on to or towards a wearer's mouth.

17. The apparatus according to claim 16, wherein said source of electromagnetic radiation comprises an IR and/or a UV source.

18. The apparatus according to claim 15, comprising a plurality of sources of electromagnetic radiation.

19. The apparatus according to claim 18, wherein each of said sources of electromagnetic radiation is curved to correspond to or approximate the shape of the teeth to which it or they are adjacent.

20. The apparatus according to claim 18, wherein each of said sources of electromagnetic radiation comprises an array of light emitting diodes.

21. The apparatus according to claim 15, further comprising temperature sensing means for sensing the temperature of gel on the surface of the person's teeth.

22. The apparatus according to claim 21, further comprising regulating means responsive to said temperature sensing means for regulating the temperature of the gel.

23. The apparatus according to claim 21, wherein said temperature sensing means is a remote or non-contact temperature sensing means.

24. The apparatus according to claim 15, wherein said support means comprises a frame arranged to be worn over the bridge of the nose and above the ears of the person in the manner of the frame of a pair of spectacles.

25. The apparatus according to claim 15, wherein said support means comprises electronic visual entertainment means.

26. A method for whitening a person's teeth in which a gel containing an oxidizing agent is applied to the teeth, said method comprising warming and maintaining said gel at a regulated temperature by an infrared radiation source, said infrared radiation source being supported by support means worn on the person's body.

27. The method according to claim 26, wherein said support means comprises a frame wearable over the bridge of the nose and above the ears in the manner of the frame of a pair of spectacles.

28. A method of whitening a person's teeth in which a gel containing an oxidizing agent is applied to the teeth, said method comprising irradiating said gel by a radiation source which is supported by support means worn on, or carried by, the person's head.

29. The apparatus according to claim 16 comprising a plurality of sources of electromagnetic radiation.

30. The apparatus according to claim 29, wherein each of said sources of electromagnetic radiation is curved to correspond to or approximate the shape of the teeth to which it or they are adjacent.

31. The apparatus according to claim 29, wherein each of said sources of electromagnetic radiation comprises an array of light emitting diodes.

32. The apparatus according to claim 16, further comprising temperature sensing means for sensing the temperature of gel on the surface of the person's teeth.

33. The apparatus according to claim 32, further comprising regulating means responsive to said temperature sensing means for regulating the temperature of the gel.

34. The apparatus according to claim 32, wherein said temperature sensing means is a remote or non-contact temperature sensing means.

35. The apparatus according to claim 16, wherein said support means comprises a frame arranged to be worn over the bridge of the nose and above the ears of the person in the manner of the frame of a pair of spectacles.

36. The apparatus according to claim 16, wherein said support means comprises electronic visual entertainment means.

37. A method of whitening a person's teeth comprising:
(a) applying a gel for teeth whitening to at least one of a person's teeth; and
(b) using an apparatus according to claim 15 to warm up the person's teeth.

38. A method of whitening a person's teeth comprising:
(a) applying a gel for teeth whitening to at least one of a person's teeth; and
(b) using an apparatus according to claim 16 to warm up the person's teeth.
